(19) United States
(12) Patent Application Publication
(10) Pub. No.: US 2026/0302104 A1
(43) Pub. Date: Oct. 1, 2026

(54) SWITCH ASSEMBLY AND ICE MAKER COMPRISING SAME

(71) Applicant: NIDEC INSTRUMENTS CORPORATION, Nagano (JP)

(72) Inventor: Yuta OSHIMA, Nagano (JP)

(21) Appl. No.: 19/574,434

(22) Filed: Mar. 23, 2026

(30) Foreign Application Priority Data
Mar. 26, 2025 (CN) 202510369793.2

(51) Int. Cl. H01H 13/86; F25C 1/22

(52) U.S. Cl. CPC H01H 13/86; F25C 1/22; F25C 2600/04

(57) ABSTRACT

A switch assembly for an ice maker includes: a support body; a first button movable relative to the support body in a first direction; a second button arranged with the first button in a second direction intersecting the first direction and movable relative to the support body in the first direction; a first switch pressable by the first button from one side in the first direction; and a second switch pressable by the second button from one side in the first direction. The first button is connected to the second button via a connecting portion, to move together with the second button. The first and second buttons can swing around an axis relative to the support body by a preset angle. The axis extends along a third direction intersecting the first and second directions, is located between the first and second buttons, and can move in the first direction.

### CROSS REFERENCE TO RELATED APPLICATION

The present invention claims priority under 35 U.S.C. § 119 to Chinese Application No. 202510369793.2 filed Mar. 26, 2025, the entire content of which is incorporated herein by reference.

### BACKGROUND

### Field of the Invention

The present invention relates to a switch assembly and an ice maker comprising the same.

### Description of the Related Documents

An existing ice maker includes: a support body; a first button movable relative to the support body in a first direction; a second button arranged with the first button in a second direction intersecting the first direction and movable relative to the support body in the first direction; a first switch configured to be pressed by the first button from one side in the first direction; and a second switch configured to be pressed by the second button from one side in the first direction.

In the above ice maker, the first button and the second button are independent of each other, so different functions can be selected by pressing the first button or the second button (for example, power on and off are switched by pressing the first button, and a test mode is selected by pressing the second button). However, on the other hand, the independent first button and second button tend to increase the quantity of components, making the ice maker uneconomical.

### SUMMARY

In view of the above problems, the present invention aims to provide a switch assembly and an ice maker comprising the same, which can decrease the quantity of components while allowing either individual pressing of one of the two switches or simultaneous pressing of both switches.

In order to achieve the above objective, the present invention provides a switch assembly, including: a support body; a first button movable relative to the support body in a first direction; a second button arranged with the first button in a second direction intersecting the first direction and movable relative to the support body in the first direction; a first switch configured to be pressed by the first button from one side in the first direction; and a second switch configured to be pressed by the second button from one side in the first direction, where the first button is connected to the second button via a connecting portion, so as to move together with the second button; the first button and the second button can swing around an axis relative to the support body by a preset angle, and the axis extends along a third direction intersecting the first direction and the second direction, is located between the first button and the second button, and can move in the first direction.

According to the switch assembly of the present invention, the first button is connected to the second button via the connecting portion, so as to move together with the second button. Therefore, the first button, the connecting portion, and the second button can be formed as one component to decrease the quantity of components. Moreover, the first button and the second button can swing around the axis relative to the support body by the preset angle, and the axis extends along the third direction intersecting the first direction and the second direction, is located between the first button and the second button, and can move in the first direction. Therefore, when a force is applied to only one of the first button and the second button towards the other side in the first direction, the first button and the second button rotate together around the axis, one of the first button and the second button moves towards the corresponding switch and presses the switch, while the other one of the first button and the second button moves away from the corresponding switch. On the other hand, when a force is applied to the first button and the second button simultaneously towards the other side in the first direction, the first button and the second button move together towards the corresponding switches and press the corresponding switches. Therefore, individual pressing of one of the two switches and simultaneous pressing of both switches can be achieved.

In the switch assembly of the present invention, preferably, the connecting portion has a shaft portion, the shaft portion can swing around the axis as a center, the support body includes a first limit portion, and the first limit portion is arranged around the shaft portion, limits the movement of the shaft portion in the second direction, but allows the shaft portion to move in the first direction.

According to the switch assembly of the present invention, the connecting portion has the shaft portion, the shaft portion can swing around the axis as the center, the support body includes the first limit portion, and the first limit portion is arranged around the shaft portion, limits the movement of the shaft portion in the second direction, but allows the shaft portion to move in the first direction. Therefore, the first button and the second button can swing around the axis and move along the first direction through simple structures.

In the switch assembly of the present invention, preferably, the connecting portion has a rod-like portion, the rod-like portion extends along the second direction and is connected to the first button and the second button at both ends, and the shaft portion protrudes from the rod-like portion towards both sides in the third direction.

According to the switch assembly of the present invention, the connecting portion has the rod-like portion, the rod-like portion extends along the second direction and is connected to the first button and the second button at both ends, and the shaft portion protrudes from the rod-like portion towards both sides in the third direction. Therefore, the shaft portion protruding from the rod-like portion towards both sides in the third direction can be limited, making the swing of the first button and the second button around the axis stable.

In the switch assembly of the present invention, preferably, the first limit portion is a groove portion, and the groove portion opens towards one side in the first direction and has side walls abutting against the shaft portion from both sides in the second direction and a bottom wall spaced apart from the shaft portion on the other side in the first direction.

In the switch assembly of the present invention, preferably, the support body includes a second limit portion, and the second limit portion is arranged around at least one of the first button and the second button, and limits the swing range of the first button and the second button around the axis based on the gap between the second limit portion and at least one of the first button and the second button in the second direction.

According to the switch assembly of the present invention, the support body includes the second limit portion, and the second limit portion is arranged around at least one of the first button and the second button, and limits the swing range of the first button and the second button around the axis based on the gap between the second limit portion and at least one of the first button and the second button in the second direction, facilitating the configuration of the swing range of the first button and the second button around the axis relative to the support body.

In the switch assembly of the present invention, preferably, the length of the first button in the first direction is different from that of the second button in the first direction.

In the switch assembly of the present invention, preferably, the connecting portion is arranged midway between the first button and the second button in the first direction.

The switch assembly of the present invention preferably further includes a circuit board, where the circuit board extends in a plane intersecting the third direction and is provided with the first button and the second button.

In the switch assembly of the present invention, preferably, the first button, the second button, and the connecting portion are integrally formed resin components.

According to the switch assembly of the present invention, the first button, the second button, and the connecting portion are integrally formed resin component, which can save assembly time and improve assembly efficiency.

In the switch assembly of the present invention, preferably, when neither the first button nor the second button is pressed, the front end of the first button is in contact with the first switch, and the front end of the second button is in contact with the second switch.

According to the switch assembly of the present invention, when neither the first button nor the second button is pressed, the front end of the first button is in contact with the first switch, and the front end of the second button is in contact with the second switch. That is, when both buttons are not pressed (in an initial state where no external force is applied to both buttons), the front end of the first button is in contact with the first switch, and the front end of the second button is in contact with the second switch. Therefore, even small movements of the buttons can be sensed by the switches.

Moreover, in order to achieve the above objective, the present invention provides an ice maker, including the switch assembly according to any of the above.

### Invention Effect

According to the present invention, the first button is connected to the second button via the connecting portion, so as to move together with the second button. Therefore, the first button, the connecting portion, and the second button can be formed as one component to decrease the quantity of components. Moreover, the first button and the second button can swing around the axis relative to the support body by the preset angle, and the axis extends along the third direction intersecting the first direction and the second direction, is located between the first button and the second button, and can move in the first direction. Therefore, when a force is applied to only one of the first button and the second button towards the other side in the first direction, the first button and the second button rotate together around the axis, one of the first button and the second button moves towards the corresponding switch and presses the switch, while the other one of the first button and the second button moves away from the corresponding switch. On the other hand, when a force is applied to the first button and the second button simultaneously towards the other side in the first direction, the first button and the second button move together towards the corresponding switches and press the corresponding switches. Therefore, individual pressing of one of the two switches and simultaneous pressing of both switches can be achieved.

### BRIEF DESCRIPTION OF THE DRAWINGS

FIG. 1 is a perspective view illustrating an ice maker according to an embodiment of the present invention.

FIG. 2 is a perspective view illustrating an ice maker according to an embodiment of the present invention, with a portion of a shell of a drive control unit removed.

FIG. 3 is a partial side cross-sectional view illustrating an ice maker according to an embodiment of the present invention.

FIG. 4 is a partial cross-sectional perspective view illustrating an ice maker according to an embodiment of the present invention.

### REFERENCE NUMERALS

1 ice maker
10 switch assembly
110 support body
111 first button
112 second button
113 connecting portion
1131 rod-like portion
1132 shaft portion
114 first switch
115 second switch
20 frame
IM ice making tray
CT drive control unit
BX open box
CV cover
CV1 cover wall
CV11 first through hole
CV12 second through hole
HD holder
HD1 holder wall
HD11 first through hole
HD12 second through hole
LM1 first limit portion
LM2 second limit portion
O axis

### DETAILED DESCRIPTION

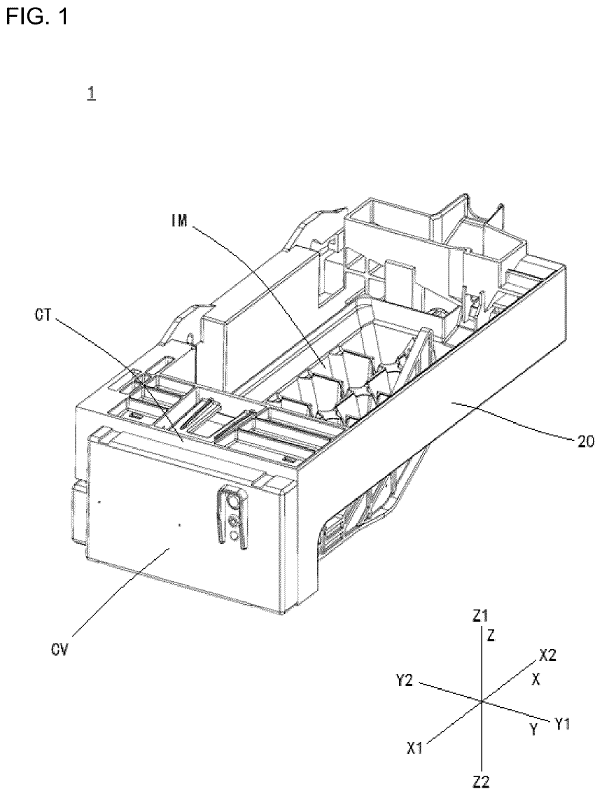

Hereinafter, an ice maker according to the embodiments of the present invention will be described with reference to FIG. 1 to FIG. 4.

Here, for the convenience of explanation, three orthogonal directions are designated as X direction, Y direction, and Z direction, with one side of the X direction designated as X1, the other side of the X direction designated as X2, one side of the Y direction designated as Y1, the other side of the Y direction designated as Y2, one side of the Z direction designated as Z1, and the other side of the Z direction designated as Z2.

### Overall Structure of an Ice Maker

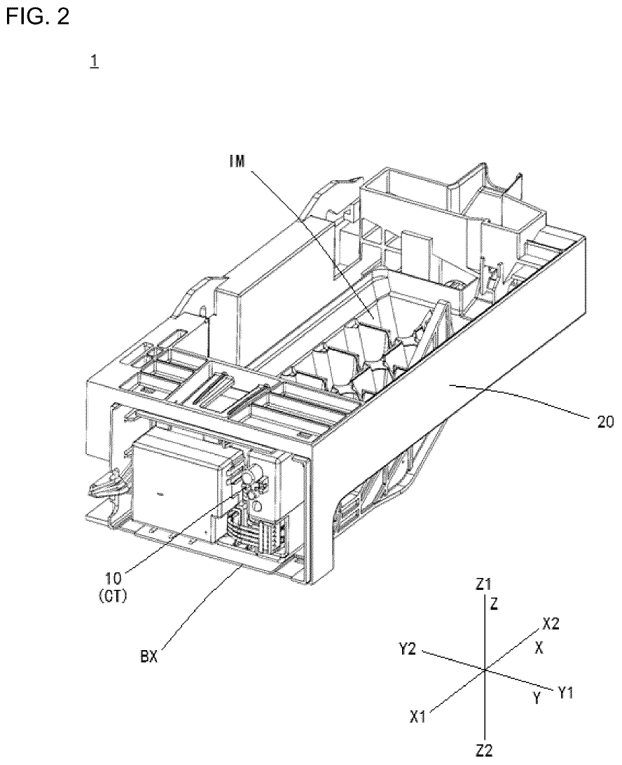

As shown in FIG. 1 and FIG. 2, the ice maker 1 includes a switch assembly 10, and the switch assembly 10 is used to switch and control power on/off, operation mode, etc. of the ice maker 1.

Here, as shown in FIG. 1 and FIG. 2, the ice maker 1 includes a frame 20. An ice making tray IM and a drive control unit CT are arranged side by side on the frame 20. The ice making tray IM can rotate around an axis extending along the arrangement direction (X direction in the illustrated example) of the ice making tray IM and the drive control unit CT. The drive control unit CT includes the switch assembly 10 and a drive source such as a motor (not shown), and can control the rotation of the ice making tray IM.

In addition, as shown in FIG. 1 and FIG. 2, the drive control unit CT includes an open box BX and a cover CV. The open box BX opens towards the X1 direction. The cover CV covers the opening of the open box BX.

### Structure of a Switch Assembly

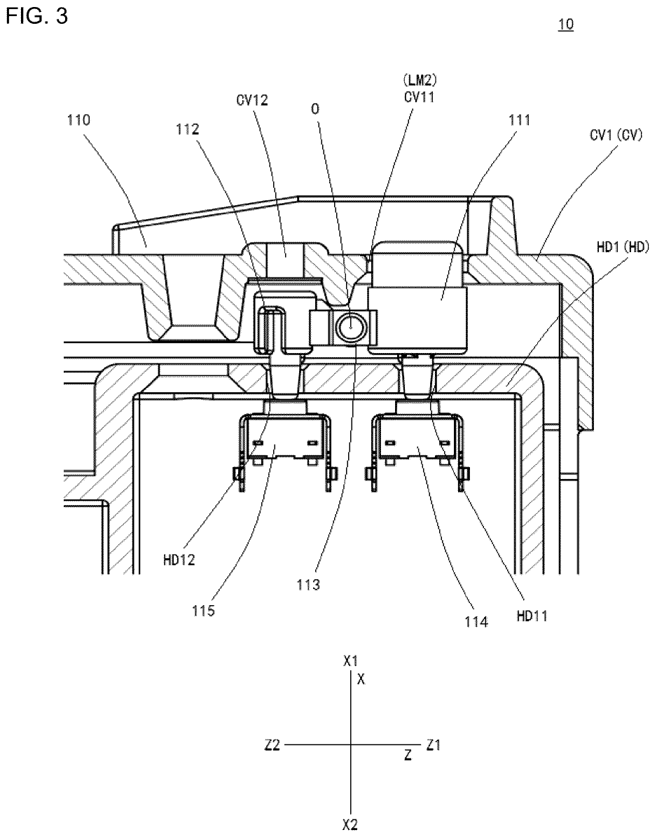

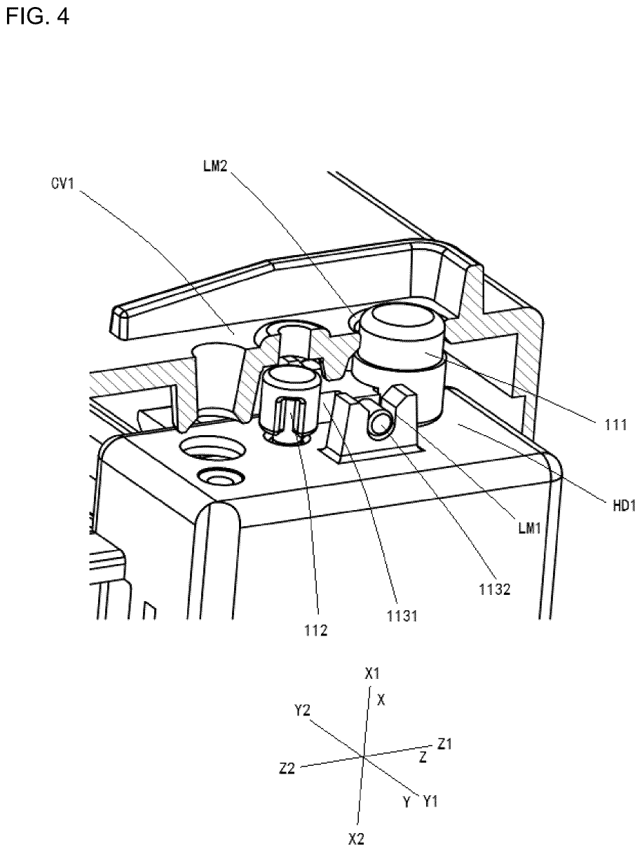

As shown in FIG. 3 and FIG. 4, the switch assembly 10 includes: a support body 110; a first button 111, where the first button 111 can move relative to the support body 110 in the X direction (equivalent to a first direction in the present invention); a second button 112, where the second button 112 is arranged with the first button 111 in the Z direction (equivalent to a second direction in the present invention) and can move relative to the support body 110 in the X direction; a first switch 114, where the first switch 114 is configured to be pressed by the first button 111 from an X1 direction side; and a second switch 115, where the second switch 115 is configured to be pressed by the second button 112 from an X1 direction side. The first button 111 is connected to the second button 112 via a connecting portion 113, so as to move together with the second button 112. The first button 111 and the second button 112 can swing around an axis O relative to the support body 110 by a preset angle (e.g., less than 5°), and the axis O extends along the Y direction (equivalent to a third direction in the present invention) and is located between the first button 111 and the second button 112.

Here, as shown in FIG. 3 and FIG. 4, the support body 110 includes a holder HD and the cover CV. The overall holder HD is shaped as a rectangular box. A circuit board (not shown), the first switch 114, and the second switch 115 are stored in the holder HD. The circuit board extends in a plane perpendicular to the Y direction (i.e., the thickness direction of the circuit board is consistent with the Y direction). The first switch 114 and the second switch 115 are arranged on the circuit board (such as on the surface of one side of the circuit board in the thickness direction). The first switch 114 is closer to a Z1 direction side than the second switch 115. The end surfaces of the first switch 114 and the second switch 115 on the X1 direction side are configured to contact and be pressed by the first button 111 and the second button 112. The cover CV is opposite to the holder HD with a gap on the X1 direction side. The main body of the first button 111, the main body of the second button 112, and the connecting portion 113 are arranged between the holder HD and the cover CV. The connecting portion 113 has a shaft portion 1132, and the shaft portion 1132 can swing around the axis O as a center. The holder HD includes a first limit portion LM1, and the first limit portion LM1 is arranged around the shaft portion 1132, limits the movement of the shaft portion 1132 in the Z direction, but allows the shaft portion 1132 to move in the X direction. The cover CV includes a second limit portion LM2, and the second limit portion LM2 is arranged around at least one of the first button 111 and the second button 112, and limits the swing range of the first button 111 and the second button 112 around the axis O based on the gap between the second limit portion and at least one of the first button 111 and the second button 112 in the Z direction.

Specifically, as shown in FIG. 3 and FIG. 4, the holder HD has a holder wall HD1 adjacent to the first switch 114 and the second switch 115 on the X1 direction side. The holder wall HD1 has a first through hole HD11 and a second through hole HD12 that penetrate along the X direction respectively. The first through hole HD11 corresponds to the first switch 114 (overlaps with the first switch 114 in the X direction), and the second through hole HD12 corresponds to the second switch 115 (overlaps with the second switch 115 in the X direction). An end of the first button 111 in the X2 direction penetrates the first through hole HD11 and abuts against the first switch 114. An end of the second button 112 in the X2 direction penetrates the second through hole HD12 and abuts against the second switch 115. The cover CV has a cover wall CV1 adjacent to the first button 111 on the X1 direction side. The cover wall CV1 has a first through hole CV11 and a second through hole CV12 that penetrate along the X direction respectively. The first through hole CV11 corresponds to the first button 111 (overlaps with the first button 111 in the X direction). The second through hole CV12 corresponds to the second button 112 (overlaps with the second button 112 in the X direction), and the diameter of the second through hole CV12 is less than that of the first through hole CV11. The end of the first button 111 on the X1 direction side penetrates the first through hole CV11. The end of the second button 112 on the X1 direction side is closer to an X2 direction side than the cover wall CV1. The connecting portion 113 is arranged midway between the first button 111 and the second button 112 in the X direction. The connecting portion 113 is located between the holder wall HD1 and the cover wall CV1 in the X direction. The connecting portion 113 has a rod-like portion 1131; the rod-like portion 1131 extends along the Z direction and is connected to the first button 111 and the second button 112 at both ends; and the shaft portion 1132 protrudes from the rod-like portion 1131 towards both sides in the Y direction. The first limit portion LM1 is a groove portion, and the groove portion opens towards the X1 direction side and has side walls abutting against the shaft portion 1132 from both sides in the Z direction and a bottom wall spaced apart from the shaft portion 1132 on the X2 direction side (in the illustrated example, the holder wall HD1 has a pair of bosses that sandwich the rod-like portion 1131 in the Y direction and protrude towards the X1 direction, and the pair of bosses are provided with groove portions for inserting the shaft portion 1132 that protrudes from the rod-like portion 1131 towards both sides in the Y direction). The second limit portion LM2 is composed of the first through hole CV11. That is, the swing range of the first button 111 and the second button 112 around the axis O is limited by the gap between the inner circumferential surface of the first through hole CV11 and the outer circumferential surface of the first button 111.

In addition, as shown in FIG. 3 and FIG. 4, the first button 111, the second button 112, and the connecting portion 113 are integrally formed resin components. The length of the first button 111 in the X direction is different from that of the second button 112 in the X direction (in the illustrated example, the length of the first button 111 is greater than that of the second button 112).

In addition, the first switch 114 is used to switch and control the power on/off of the ice maker 1, and can usually be pressed directly by hand. The second switch 115 is used to switch and control the operation modes (such as normal mode and test mode) of the ice maker 1, and can usually be pressed by means of a tool. The first switch 114 and the second switch 115 are, for example, tactile switches.

Furthermore, preferably, when neither the first button 111 nor the second button 112 is pressed, the front end of the first button 111 is in contact with the first switch 114, and the front end of the second button 112 is in contact with the second switch 115.

### Main Effect of This Embodiment

According to the ice maker 1 of this embodiment, the first button 111 is connected to the second button 112 via the connecting portion 113, so as to move together with the second button 112. Therefore, the first button 111, the connecting portion 113, and the second button 112 can be formed as one component to decrease the quantity of components. Moreover, the first button 111 and the second button 112 can swing around the axis O relative to the support body by the preset angle, and the axis O extends along the Y direction, is located between the first button 111 and the second button 112, and can move in the X direction. Therefore, when a force is applied to only one of the first button 111 and the second button 112 towards the X2 direction side, the first button 111 and the second button 112 rotate together around the axis O, one of the first button 111 and the second button 112 moves towards the corresponding switch and presses the switch, while the other one of the first button 111 and the second button 112 moves away from the corresponding switch. On the other hand, when a force is applied to the first button 111 and the second button 112 simultaneously towards the X2 direction side, the first button 111 and the second button 112 move together towards the corresponding switches and press the corresponding switches. Therefore, individual pressing of one of the two switches and simultaneous pressing of both switches can be achieved.

In addition, according to the ice maker 1 of this embodiment, the connecting portion 113 has the shaft portion 1132, the shaft portion 1132 can swing around the axis O as the center, the support body 110 includes the first limit portion LM1, and the first limit portion LM1 is arranged around the shaft portion 1132, limits the movement of the shaft portion 1132 in the Z direction, but allows the shaft portion 1132 to move in the X direction. Therefore, the first button 111 and the second button 112 can swing around the axis O and move along the X direction through simple structures.

The present invention is illustrated above with reference to the drawings. Apparently, the specific implementation of the present invention is not limited by the above embodiments.

For example, in the above embodiments, the switch assembly 10 is applied but not limited to the ice maker, and the switch assembly 10 may also be applied to other occasions.

In the above embodiments, the length of the first button 111 in the X direction is different from that of the second button 112 in the X direction, but is not limited thereto, and the length of the first button 111 in the X direction may be the same as that of the second button 112 in the X direction.

In the above embodiments, the first button 111, the second button 112, and the connecting portion 113 are made of but not limited to resin, and may be made of other materials such as metal.

In the above embodiments, the shaft portion 1132 protrudes from the rod-like portion 1131 towards both sides in the Y direction, but is not limited thereto, and the shaft portion 1132 may protrude from the rod-like portion 1131 towards only one side in the Y direction.

In the above embodiments, the first limit portion LM1 is a groove portion, but is not limited thereto, and the first limit portion LM1 may be composed of only a pair of walls sandwiching the shaft portion 1132 in the Z direction.

In the above embodiments, the second limit portion LM2 is composed of the first through hole CV11, but is not limited thereto, and the second limit portion LM2 may be composed of other portions, such as a wall portion protruding towards the X2 direction side on the cover wall CV1 or a wall portion protruding towards the X1 direction side on the holder wall HD1, and the second limit portion LM2 is composed of that wall portion.

In the above embodiments, the circuit board extends in the plane perpendicular to the Y direction, but is not limited thereto, and the circuit board may extend in a plane perpendicular to the X direction.

In the above embodiments, the first direction, the second direction, and the third direction are orthogonal to each other, i.e., intersect with a 90-degree angle, but is not limited thereto, and the first direction, the second direction, and the third direction may intersect with an angle other than 90 degrees.

It should be understood that, within the scope of the present invention, various parts in the embodiments can be freely combined or appropriately modified or omitted.

What is claimed is:

1. A switch assembly comprising: a support body; a first button movable relative to the support body in a first direction; a second button arranged with the first button in a second direction intersecting the first direction and movable relative to the support body in the first direction; a first switch configured to be pressed by the first button from one side in the first direction; and a second switch configured to be pressed by the second button from one side in the first direction, wherein
the first button is connected to the second button via a connecting portion, so as to move together with the second button; and
the first button and the second button can swing around an axis relative to the support body by a preset angle, and the axis extends along a third direction intersecting the first direction and the second direction, is located between the first button and the second button, and can move in the first direction.

2. The switch assembly according to claim 1, wherein
the connecting portion has a shaft portion, the shaft portion can swing around the axis as a center, and
the support body comprises a first limit portion, and the first limit portion is arranged around the shaft portion, limits the movement of the shaft portion in the second direction, but allows the shaft portion to move in the first direction.

3. The switch assembly according to claim 2, wherein
the connecting portion has a rod-like portion, the rod-like portion extends along the second direction and is connected to the first button and the second button at both ends, and
the shaft portion protrudes from the rod-like portion towards both sides in the third direction.

4. The switch assembly according to claim 2, wherein
the first limit portion is a groove portion, and the groove portion opens towards one side in the first direction and has side walls abutting against the shaft portion from both sides in the second direction and a bottom wall spaced apart from the shaft portion on the other side in the first direction.

5. The switch assembly according to claim 2, wherein
the support body comprises a second limit portion, and the second limit portion is arranged around at least one of the first button and the second button, and limits the swing range of the first button and the second button around the axis based on the gap between the second limit portion and at least one of the first button and the second button in the second direction.

6. The switch assembly according to claim 1, wherein
the length of the first button in the first direction is different from that of the second button in the first direction.

7. The switch assembly according to claim 1, wherein
the connecting portion is arranged midway between the first button and the second button in the first direction.

8. The switch assembly according to claim 1, further comprising:
a circuit board,
wherein the circuit board extends in a plane intersecting the third direction and is provided with the first button and the second button.

9. The switch assembly according to claim 1, wherein
the first button, the second button, and the connecting portion are integrally formed resin components.

10. The switch assembly according to claim 1, wherein
when neither the first button nor the second button is pressed, the front end of the first button is in contact with the first switch, and the front end of the second button is in contact with the second switch.

11. An ice maker comprising the switch assembly according to claim 1.
